(19) United States
(12) Patent Application Publication
(10) Pub. No.: US 2025/0134128 A1
(43) Pub. Date: May 1, 2025

(54) EDIBLE COMPOSITIONS COMPRISING DEAMIDATED LEGUME PROTEIN ISOLATES

(71) Applicant: CORN PRODUCTS DEVELOPMENT, INC., WESTCHESTER, IL (US)

(72) Inventors: Xin YANG, Bridgewater, NJ (US); Alexandra CUMMINS, Bridgewater, NJ (US); Josephine STAMEY, Bridgewater, NJ (US)

(21) Appl. No.: 18/832,189

(22) PCT Filed: Jan. 23, 2023
(86) PCT No.: PCT/US2023/011315

§ 371 Date: Jul. 23, 2024

Related U.S. Application Data
(60) Provisional application No. 63/305,893, filed on Feb. 2, 2022.

(51) Int. Cl. A23G 9/38; A23C 11/10; A23D 7/005; A23G 9/32; A23G 9/34; A23J 3/14; A23L 23/00; A23L 29/10; A23L 29/212

(52) U.S. Cl. CPC A23G 9/38; A23C 11/103; A23D 7/0053; A23G 9/327; A23G 9/34; A23J 3/14; A23L 23/00; A23L 29/10; A23L 29/212

(57) ABSTRACT

This specification describes edible compositions comprising a deamidated legume protein isolate. The compositions comprise deamidated legume protein in an amount of at least 0.5% (wt. % of the composition). Also the deamidated legume protein isolate has a degree of deamidation from about 10% to 25% with reference to legume protein isolate that has not been deamidated. Illustrative edible compositions comprise the deamidated legume protein isolate and some illustrative compounds further comprise a fat component and an aqueous component.

The technology disclosed in this specification pertains deamidated legume protein isolates, and more particularly to uses of deamidated legume protein isolates in edible compositions.

Legume protein isolates are useful food ingredients and can be used in various edible compositions (which for convenience in this specification includes beverage compositions) to provide nutrition or structure. This specification describes a modified legume protein isolate that has improved emulsifying function compared to the base legume protein isolate. More specifically, this specification discloses deamidated legume protein isolates, particularly those derived from pea proteins. This specification also discloses edible compositions comprising the disclosed deamidated legume protein isolates.

In one aspect this specification describes edible compositions comprising deamidated legume protein isolates. More specifically, deamidated legume protein isolates are protein rich compositions obtained by isolating legume protein from other components in a legume seed or legume flour and concurrently or subsequently to the isolation process, subjecting the legume protein to a deamidation reaction that converts at least some of the asparagine or glutamine residues therein to aspartic acid or glutamic acid residues.

Any process for isolating legume protein from legume seed or legume flour and deamidating the protein may be used. An illustrative process follows describing process that first isolates and then deamidates legume protein. Legume protein can be isolated from other components of the legume see using known methods. For example International Patent Application PCT/US2022/019911, which is incorporated in its entirety into this specification by reference, describes a method for isolating pea protein from pea flour by adjusting the pH of a slurry containing pea flour. Such processes take advantage of the changes in the solubility of pea protein relative to solubility of other components in the flour at different pHs. In the described process, legume proteins tend to be highly soluble at pH above 8 while starch and fiber remain highly insoluble. Once dissolved in water or other liquid at pH around 8, legume protein solution can be separated from soluble matter using one or more of filtration and centrifugations. The dissolved protein can then be recovered by lowering the pH to about 4 where the protein is highly insoluble. The precipitated protein can then be removed from the water or other liquid using one or more of filtration and centrifugation and then the protein can be further dried to an equilibrium moisture content.

Referring now to the deamidation process, deamidation can occur enzymatically or chemically. Generally the process converts amide functional groups in asparagine or glutamine to obtain aspartic acid or glutamic acid groups. In at least some embodiments the deamidation reactions uses a glutaminase enzyme, which converts glutamine residues in the proteins and polypeptides in the legume protein isolate to glutamic acid residues. Illustrative methods for deamidating legume proteins (in particular pea proteins) are described in International Patent Application PCT/US2021/033127, which is incorporated herein by reference.

Deamidated legume protein isolates in any embodiment described in this specification obtained have protein content (dry weight basis or as is weight basis) of greater than about 70%, or greater than about 75%, or from about 75% to about 90%, or from about 75% to about 85% protein. In any embodiment a deamidated legume protein isolate described in this specification, has a degree of deamidation of between 10% and about 25%, or about 10% and about 20%, or about 12% to about 20% or about 15% to about 20% compared to the base legume protein. In at least some embodiments a deamidated legume protein isolate as described in this specification is a deamidated pea protein isolate. Other use legume protein isolates include lentil, fava bean, chickpea.

With reference to edible compositions described in this specification, in any embodiment, an edible composition is a mixture comprising: a fat; an aqueous component; and a deamidated legume protein isolate in an amount from about 0.5 (wt. %), to about 3%, or about 2.5%, or about 2% or from about 1% (wt. %) to about 3%, or to about 2.5%, or to about 2% wherein the deamidated legume protein isolate has a degree of deamidation of between about 10% and about 25%, or about 10% to about 20%, or about 12% to about 20%, or about 15% to about 20%. In at least some embodiments of the edible composition, the deamidated legume protein isolate is a deamidated pea protein isolate.

In any embodiment of an edible composition described in this specification, comprises a fat or oil or has a fat content or oil content an amount from about 5% to about 50%, to about 40%, or to about 30%, or to about 20%, or to about 15%. In at least some embodiments of the edible composition, the fat is a plant derived oil, the composition is preferably a vegan composition. In embodiments where the edible composition comprises a fat from a plant derived oil, the oil is in an amount of a greater than 10%, or from 11% to about 50%, to about 40%, or to about 30%, or to about 20%, or to about 15%. In at least some other embodiments of the edible composition, the fat is from an animal source. The composition of claim 1 having a fat content from about 5% or about 10% to about 30%, or to about 25%, or two about 20%, or to about 15% (wt. %).

In any embodiment of an edible composition described in this specification, the composition is an oil-in-water emulsion having a viscosity at least about 5,000 mPa·s or from about 5,000 or from to about 12,000 or to about 8,000 mPa·s at, or from about 6,000 to about 12,000 or to about 8,000 mPa·s at a temperature of about 20° to about 25° C. In any embodiment of an edible composition described in this specification the edible composition is a freeze/thaw stable oil-in-water emulsion and such that emulsion does not break, meaning that oil does not separate from the aqueous phase and pool on the broken emulsion when the emulsion is frozen and thawed to serving temperature (from 20° to 40). An illustrative thawing process uses a microwave oven (1250 W) on high for 1 minute to thaw the sauce (40 g sample). The significance of this test is that the emulsion does not break during phase transition from frozen to thawed and does not break during the rapid introducing of heat to prepare the sauce, which provide an additional stress on the emulsions. (The heating in this test can be done using a microwave oven or conventional stove top or similar device.) In any embodiment of an edible composition described in this specification the edible composition is a freeze/thaw stable oil-in-water emulsion wherein after freezing and thawing the composition the composition has a viscosity having a viscosity at least about 5,000 mPa·s or from about 5,000 or from to about 12,000 or to about 8,000 mPa·s at, or from about 6,000 to about 12,000 or to about 8,000 mPa·s at a temperature of about 20° to about 25° C.

In any embodiment, an edible composition as described in this specification further comprises a starch. Use starch including but not limited to corn starch, tapioca starch, pea starch, fava bean starch, lentil starch, chickpea starch, tapioca starch, potato starch, and sago starch as well as high amylose and low amylose variants of such starches. Such starches also may be within flours and meals including wheat flour and nut meals. Useful starches may be modified or unmodified. Modified starches modified using chemical mean, enzymatic means, or physical means, and mixtures thereof. Use chemical modifications include crosslinked including by using phosphate or adipate, or stabilization including by hydroxypropyl or acetyl moieties. Useful starch may be converted or hydrolyzed using shear, enzyme, acid, or oxidation. Starch may also be modified usefully by oxidation for purposes other than hydrolysis. Useful starch may be physically modified such as by thermal inhibition, annealing, gelatinization, or heat moisture treatments. Modified and unmodified starch may be pregelatinized or otherwise made cold water soluble.

In at least some embodiments the edible composition the starch is a thermally inhibited starch. Here, thermally inhibited starches can be made using any process. An illustrative processes dehydrates the starch and heats the dehydrated starch to functionalize the starch so that it functions like a chemically crosslinked starch. More detailed methods of manufacture and embodiments of thermally inhibited starches are disclosed for example in U.S. Pat. No. 5,725,676, which is incorporated into this document by reference in its entirety. Thermally inhibited starches are also commercially available for example from Ingredion Incorporated). In any embodiment of the edible composition described in this specification, the starch is in an amount from about 1% to about 10%, or to about 5% (wt. %).

In any embodiment of the edible composition described in this specification, the composition is an oil-in-water emulsion having a pH from about 6 to about 8, or from about 6.5 to about 7.5. The pH is chosen so that the deamidated legume protein concentrate is highly soluble. In any embodiment described in this specification, an edible composition comprises a deamidated legume protein isolate wherein at least about 30% or at least about 35% or the deamidated legume protein isolated is dissolved in water. In any embodiment described in this specification, an edible composition comprises a deamidated legume protein isolate wherein the deamidated pea protein isolate is dissolved in an aqueous phase of the emulsion. In any embodiment described in this specification, an edible composition comprises a deamidated legume protein isolate wherein the isolate is at least substantially dissolved such that deamidated legume protein isolate is not apparent under brightfield microscopy at 200× magnification.

In any embodiment described in this specification a deamidated legume protein isolate stabilizes an oil or fat globule as evidence by the globule size. Stable oil droplets are usually characterized as having fat globules having size less than about 20 microns or more preferrable less than about 15 microns, or most preferably about 10 microns or less. Fat or oil globules can be distinguished from other particles visually using brightfield microscopy where globules appear as a relatively opaque circle-like boundary surrounding a comparatively translucent interior.

In any embodiment described in this specification, an edible composition comprises a deamidated legume protein isolate that is highly soluble. The degree of solubility can be inferred by particles distributions. Here particles can be distinguished from the background and from globules using brightfield microscopy where particles are relatively opaque localized objects without a comparatively translucent interior. Insoluble protein tends to aggregate and form large particles. Soluble proteins, in contrast, dissolve into solution and cannot be detected as particles. In any embodiment described a composition as described in this specification has a particle size distribution having a mean particle size (volume weighted) of less than about 5 microns or less than about 3 microns. In any embodiment described in this specification, an edible composition comprises a deamidated legume protein isolate wherein the composition has a particle size distribution having a d (90) less than about 10 microns, or less than about 7 microns, or less than about 6 microns. In at least some embodiments the forgoing particle size distributions are obtainable in a frozen dairy composition.

Focusing further on embodiments of the edible composition where the fat is from an animal source, one class of such compositions are aerated frozen dairy compositions. Ice creams are a useful, nonlimiting example. In frozen dairy confection there is an oil in water emulsion of fat. The emulsified fat undergoes partial coalescence during freezing, which encapsulates air cells. In stable ice creams and ice cream batters (pre-freezing) air cells stably exist and are distributed throughout the composition.

If no emulsifier is used or if a poor emulsifier is used the ice cream does not hold air bubbles, which adversely affects the texture of the ice cream. The lack of bubbles is apparent in brightfield microscopy of the frozen composition. The lack of stability of the distribution of the bubbles can also been seen without magnification when the frozen composition melts. In the terminology of the art there is visible serum separation, meaning there is a liquid portion of the melted or melting composition that visible does not contain air bubbles. In any embodiment described in this specification, an edible composition comprises a deamidated legume protein isolate (or deamidated pea protein isolate) and exhibits no serum separation during melting over a period of 60 minutes.

In another aspect, the technology disclosed in this specification pertains to use of deamidated legume protein isolates, or deamidated pea protein isolates as described in any described in this specification as an emulsifier. In at least some embodiments, deamidated legume protein isolates or deamidated pea protein isolates are used as described in this specification to replace monoglyceride and diglyceride. In at least some embodiments the deamidated legume protein isolate or deamidated pea protein isolate is used to replace monoglyceride and diglyceride in a frozen dairy composition.

Other useful ingredients for the disclosed edible composition follow.

In any embodiment, an edible composition as described in this specification further comprises a sweetener. Useful sweeteners include honey, allulose, tagatose, fructose, glycerol, sucrose, rebaudiosides (A, B, J, M, etc.), and glucosylated stevia glycosides, corn syrups including high fructose corn syrups. Sweeteners may be provided in solid, or powdered, or liquid, or syrup form.

In any embodiment, an edible composition as described in this specification further comprises a fiber. Useful fibers may include cellulosic fibers from any botanical source, resistant starches, soluble fibers such as polydextrose or short chain fructooligosacchardies.

In any embodiment, an edible composition as described in this specification further comprises a gum or gum-like material. Useful gums and gum like materials include gelling starches, gum Arabic, xanthan gum, tara gum, konjac, carrageenan, locust bean gum, gellan gum, guar gum, pectin, and modified celluloses like carboxymethyl cellulose, and mixtures thereof.

In any embodiment, an edible composition comprising a deamidated legume protein isolate described in this specification useful fats include oils including vegetable oils such as corn oil, olive oil, canola oil, sunflower oil, rapeseed oil, palm oil, coconut oil.

Useful fats (other than vegetable oils) included animal fats and dairy fats. Most preferably the fat is a dairy fat or butter fat which may be provided like cow's milk or cow's milk cream of desired fat content.

Useful aqueous ingredients include water, milk (including non-fat milk), syrups, juices from fruits or vegetables, fruit or vegetable purees, or other carbohydrate containing liquids, or acidic liquids, or basic liquids.

In any embodiment, an edible composition comprising a deamidated legume protein isolate described in this specification may further comprises various other flavorings and coloring commonly used in edible composition.

The subject matter described in this specification can be better understood with reference to the following definitions and other guidance for construing the terms in this specification.

Reference to the term “aqueous component” refers to a component comprising water regardless of its phase (solid, liquid, gaseous, etc.). Aqueous components may comprise other ingredients which are suspended, dispersed, dissolved, or otherwise mixed in the aqueous component. Aqueous components have various pH. Non-limiting examples of aqueous components are water (whether in liquid form, as steam, or as ice), milk, juice, puree, syrup, acidic liquids like vinegar, alkaline liquids, and similar ingredients.

The term “degree of deamidation” in this specification refers to the amount of ammonia released during deamidation a reaction compared to the total ammonia of releasable by the protein. In practice degree of deamidation can also be determined by comparing the amount of ammonia released by a protein of interest compared to a reference protein of the same type that was not deamidated. For example, it is common that legume protein isolates are substantially comprised of globular type protein proteins, which can be determined by the molecular weight measurements of the proteins in the isolate. Taking as a further example a pea protein isolate comprised substantially of globular type proteins, its degree of deamidation can be determined by comparing the target to a sample to can be compared to non-deamidated reference pea protein isolate of similar protein time.

Within this specification, degree of deamidation is reported as a percentage. Degree of deamidation can be calculated using any suitable method in the art. A useful test for measuring degree of deamidation follows. Disperse protein (deamidated protein or reference unmodified protein in slurry with 2M H₂SO₄ and incubate solution at boiling temperature (about 100° C.) for 2 hours. Mix three volumes of resultant slurry with 1 volume of 40% trichloroacetic acid (“TCA”) solution to obtain mixture having a final TCA concentration of 10%. Centrifuged at 4,000 g for 10 min. Free ammonia content in the supernatant is determined using a commercial ammonia analysis kit (Megazyme). Degree of deamidation equals total ammonia release divided by total ammonia obtainable multiplied by 100.

Reference in this specification to “globule size” refers to the size distribution of oil or fat globules in an edible composition. Globule size is measured using laser scattering and may be done using any suitable apparatus. Within this specification globule size is measured using a Beckman Coulter particle size analyzer, which measures particle (or globule) size using laser diffraction (ranges from 0.2 μm-1600 μm). The Beckman Coulter particle size analyzer has a setting allowing for analysis of different fat/oil types, for example globule size in illustrative ice creams were measured using settings to detect milkfat. Globule sizes (including mean globule size) are reported in this specification in microns and refer to the diameter of the referred to globule in the distribution. Mean globule sizes are volume weighted mean globule size, sometimes called a volume mean size or a D4,3 mean.

Reference in this specification to “particle size” refers to the size distribution of particles in an edible composition. Particle size is measured using laser scattering and may be done using any suitable apparatus and provides a guide as to protein solubility as insoluble proteins tend to aggregate and form larger particles. Within this specification particle size is measured using of a Beckman Coulter particle size analyzer, which measures particle size using laser diffraction (ranges from 0.2 μm-1600 μm). Particle sizes reported in this specification are in microns and refer to the diameter of the referred to particle in the distribution. Mean particle sizes reported are volume weighted mean particle size sometimes called a volume mean particle sizes or a D4,3 means.

Within this specification, some products are characterized by their viscosity. Viscosities are measured using Brookfield viscometer with t-bar B at room temperature (unmeasured from about 20° to about 25° C.) for 30 seconds with the bar rotating at 10 revolutions per minute.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification can be better understood with reference to the following aspects, which are not intended to limit the full scope of the described technology.

1. An edible composition being a mixture comprising: a fat component; an aqueous component; and a deamidated legume protein isolate in an amount from about 0.5, or about 1% to about 3%, or about 2.5%, or about 2%; wherein the deamidated legume protein isolate has a degree of deamidation of between about 10% and about 25%, or about 10% to about 20%, or about 12% to about 20%, or about 15% to about 20%.

2. The composition of claim 1 wherein the deamidated legume protein isolate is a deamidated pea protein isolate.

3. The composition of claim 1 or 2 wherein the fat component in an amount from about 5% to about 50%, to about 40%, or to about 30%, or to about 20%, or to about 15%.

4. The composition of any one of claims 1 to 3 wherein the fat component is a plant derived oil.

5. The composition of any one of claims 1 to 4 wherein the fat component is a plant derived oil in an amount of a greater than 10%, or from 11% to about 50%, to about 40%, or to about 30%, or to about 20%, or to about 15%.

6. The composition of any one of claims 1 to 5 wherein the composition is an oil-in-water emulsion having a viscosity at least about 5,000 mPa·s or from about 5,000 or from about 6,000 to about 12,000 or to about 8,000 mPa·s at a temperature of about 20° to about 25° C.

7. The composition of any one of claims 1 to 6 wherein the composition is an oil-in-water emulsion and wherein after freezing and thawing the composition the composition has a viscosity at least about 5,000 mPa·s or from about 5,000 or from about 6,000 to about 12,000 or about, 10,000 or to about 8,000 mPa·s at a temperature of about 20° to 25° C.

8. The composition of any one of claims 1 to 7 being an oil in water emulsions wherein after freezing and thawing the emulsion is not broken wherein, optionally, thawing is done by heating a 40 g sample of the frozen composition in a 1250 W microwave oven on high for one minute.

9. The composition of any one of claims 1 to 8 further comprising a starch, wherein the starch is selected from the group consisting of corn, potato, tapioca, rice, pea, waxy corn, waxy potato, way rice, waxy tapioca, and mixtures thereof, wherein, preferably, the starch is a thermally inhibited starch, and wherein, preferably, the starch is a waxy tapioca starch, wherein optionally the starch is in an amount from about 1% to about 10%, or to about 5% (wt. %).

10. The composition of claims 1 to 9 being an oil-in-water emulsion having a pH from about 6 to about 8, or from about 6.5 to about 7.5.

11. The composition of any one of claims 1 to 10 being a vegan composition.

12. The composition of any one of claims 1 to 11 having a fat content in an amount from about 5% or about 10% to about 30%, or to about 25%, or two about 20%, or to about 15% (wt. %) wherein optionally the composition has a fat component is in an amount from about 5% or about 10% to about 30%, or to about 25%, or two about 20%, or to about 15% (wt. %).

13. The composition of claim 12 wherein the fat is from an animal source, preferably from a dairy source.

14. The composition of claims 12 and 13 being a frozen dairy composition.

15. The composition of claims 12 to 14 wherein the composition exhibits no serum separation during melting over a period of 60 minutes.

16. The composition as described in any foregoing claim wherein at least about 30% or at least about 35% or the deamidated legume protein isolated is dissolved in water.

17. The composition of any foregoing claim wherein the deamidated pea protein isolate is dissolved in an aqueous phase of the emulsion.

18, The composition of any foregoing claim having a particle size distributions having a mean particle size of less than about 5 microns or less than about 3 microns optionally wherein the composition is a frozen dairy composition.

19. The composition of any foregoing claim having a particle size distributions having a d (90) less than about 10 microns, or less than about 7 microns, or less than about 6 microns optionally wherein the composition is a frozen dairy composition.

20. The composition of any foregoing claim having a mean globule size less than about 20 microns, or less than about 15 microns or, about 10 microns or less.

21. The composition of any forgoing claim wherein the composition does not comprise a monoglyceride or a diglyceride.

22. A method of making a food composition comprising mixing a deamidated legume protein isolate as described in any foregoing claim with an aqueous component and a fat component to form a composition as described in any foregoing claim;
wherein optionally the mixing forms an emulsion,
wherein optionally after mixing the composition is frozen.

23. Use of a deamidated legume protein isolate as described in any foregoing claim as an emulsifier, wherein, optionally the deamidated legume protein isolate is a deamidated pea protein isolate.

24. Use of a deamidated legume protein isolate as described in claim 23 to replace monoglyceride and diglyceride, wherein optionally, the deamidated legume protein isolate is replacing monoglyceride and diglyceride in a frozen dairy composition. The technology described in this specification can be better understood with reference to the following aspect, which are not intended to limit the full scope of the disclosed technology.

An edible composition being a mixture comprising: A) a fat component; B) an aqueous component; and C) a deamidated legume protein isolate in an amount from about 0.5 (wt. %), to about 3%, or about 2.5%, or about 2% or from about 1% (wt. %) to about 3%, or to about 2.5%, or to about 2% wherein the deamidated legume protein isolate has a degree of deamidation of between about 10% and about 25%, or about 10% to about 20%, or about 12% to about 20%, or about 15% to about 20%.

The composition of claim 1 wherein the deamidated legume protein isolate is a deamidated pea protein isolate.

The composition of claim 1 or 2 wherein the fat component is present in an amount from about 5% to about 50%, to about 40%, or to about 30%, or to about 20%, or to about 15%.

The composition of any one of claims 1 to 3 wherein the fat component is a plant derived oil.

The composition of any one of claims 1 to 4 wherein the fat component is a plant derived oil present in an amount of a greater than about 10%, or from about 11% to about 50%, or to about 40%, or to about 30%, or to about 20%, or to about 15%.

The composition of any one of claims 1 to 5 wherein the composition is an oil-in-water emulsion having a viscosity at least about 5,000 mPa·s or from about 5,000 or from to about 12,000 or to about 8,000 mPa·s at, or from about 6,000 to about 12,000 or to about 8,000 mPa·s at a temperature of about 20° to about 25° C.

The composition of any one of claims 1 to 6 wherein the composition is an oil-in-water emulsion and wherein after freezing and thawing the composition the composition has a viscosity at least about 5,000 mPa·s, or from about 5,000 to about 12,000 or to about 10,000, or to about 8,000 mPa·s or from about 6,000 to about 12,000 or to about 10,000 or to about 8,000 mPa·s at a temperature of about 20° to 25° C.

The composition of any one of claims 1 to 7 being an oil in water emulsions wherein after freezing and thawing the emulsion is not broken; wherein, optionally, thawing is done by heating a 40 g sample of a frozen composition in a 1250 W microwave oven on high for one minute.

The composition of any one of claims 1 to 8 further comprising a starch, wherein the starch is selected from the group consisting of corn, potato, tapioca, rice, pea, waxy corn, waxy potato, way rice, waxy tapioca, and mixtures thereof, wherein, preferably, the starch is a thermally inhibited starch, and wherein, preferably, the starch is a waxy tapioca starch, wherein optionally the starch is present in an amount from about 1% to about 10%, or to about 5% (wt. %).

The composition of claims 1 to 9 being an oil-in-water emulsion having a pH from about 6 to about 8, or from about 6.5 to about 7.5.

The composition of any one of claims 1 to 10 being a vegan composition.

The composition of any one of claims 1 to 11 having a fat content in an amount from about 5% to about 30%, or to about 25%, or two about 20%, or to about 15% (wt. %), or from about 10% to about 30%, or to about 25%, or two about 20%, or to about 15% (wt. %); wherein optionally the composition has a fat component present in an amount from about 5% to about 30%, or to about 25%, or two about 20%, or to about 15% (wt. %), or from about 10% to about 30%, or to about 25%, or two about 20%, or to about 15% (wt. %).

The composition of claim 12 wherein the fat is from an animal source, preferably from a dairy source.

The composition of claim 12 or 13 being a frozen dairy composition.

The composition of any one of claims 12 to 14 wherein the composition exhibits no serum separation during melting over a period of 60 minutes.

The composition as described in any foregoing claim wherein at least about 30% or at least about 35% of the deamidated legume protein isolated is dissolved in water.

The composition of any foregoing claim wherein the deamidated pea protein isolate is dissolved in an aqueous phase of the emulsion.

The composition of any foregoing claim having a particle size distributions having a mean particle size of less than about 5 microns or less than about 3 microns; optionally wherein the composition is a frozen dairy composition.

The composition of any foregoing claim having a particle size distributions having a d (90) less than about 10 microns, or less than about 7 microns, or less than about 6 microns; optionally wherein the composition is a frozen dairy composition.

The composition of any foregoing claim having a mean globule size less than about 20 microns, or less than about 15 microns, or about 10 microns or less.

A method of making a food composition comprising mixing a deamidated legume protein isolate as described in any foregoing claim with an aqueous component and a fat component to form a composition as described in any foregoing claim; wherein optionally the mixing forms an emulsion, wherein optionally after mixing the composition is frozen.

Use of a deamidated legume protein isolate as described in any foregoing claim as an emulsifier, wherein, optionally the deamidated legume protein isolate is a deamidated pea protein isolate.

Use of a deamidated legume protein isolate as described in claim 20 to replace monoglyceride and diglyceride, wherein optionally, the deamidated legume protein isolate is replacing monoglyceride and diglyceride in a frozen dairy composition.

The technology disclosed in this specification is further described by reference to the following examples, which are not intended to limit the full scope of the described technology.

### EXAMPLE 1: OIL-IN WATER EMULSION BASED SAUCE USING DEAMIDATED PEA PROTEIN ISOLATE

Deamidated pea protein isolates were deamidated enzymatically using glutaminase enzyme using methods as described in International Patent Application PCT/US2021/033127, which is incorporated herein by reference. Oil-in-water emulsion-based sauces were made according to the formula described in Table 1. Sauces were made with various pea protein isolates to compare quality of the emulsion according using viscosity. Viscosity is a useful proxy for emulsion quality because better emulsions have better dispersed, smaller oil than lower quality emulsions, which commonly correlates with higher emulsions viscosity. Emulsions samples were made using non-deamidated pea protein isolate having about 80% protein content (Sample 1), non-deamidated pea protein isolate having about 85% protein content (Sample 2), and deamidated pea protein isolate having about 80% protein content having degree of deamidated between 15% and 20% (Sample 3).

TABLE 1
Formula for Oil in Water Emulsion-based Sauce

| | Usage level |
|---|---|
| Ingredients | (wt. %) |
| WET INGREDIENTS | |
| Vegetable Oil | 12 |
| Water | 57.762 |
| Cauliflower Puree | 17.05 |
| Butternut Squash Puree | 5.6 |
| DRY INGREDIENTS | |
| Thermally inhibited Waxy Tapioca | 3.19 |
| Starch | |
| Soluble Corn fiber | 1.02 |
| Yeast Extract | 0.07 |
| Pea Protein Isolate | 1.5 |
| Salt and seasonings | 1.808 |
| Total | 100 |

Wet ingredients were mixed using a standing mixer (from Thermomix®, Inc.) until homogenous, reserving oil, to form a wet mix. Dry ingredients were mixed to form a dry mix in a separate bowl (reserving some seasoning). Mixer speed was set to 1 and dry mix was spooned into wet mix to form a slurry. Speed was increased to speed to 2.5 and oil was added to form a coarse emulsion. Coarse emulsion was heated to 85° C. on speed 2, for about 18 minutes (to obtain a good cook). Coarse emulsions were transferred to a high sheer mixer (Scott Turbon Mixer) and was mixed for 2 minutes at 45 Hz. The rest of the ingredients were added.

The deamination process formed stable, smooth oil-in-water based emulsions sauces having viscosity of about 7000 mP·s. In contrast sauces made using pea protein isolates that were not deamidated, regardless of protein content, were less viscous than emulsions made using deamidated pea protein isolate, having viscosity of about 6000 mP·s.

Sauces of the type described in this example are commonly sold frozen and then thawed for use to a serving temperature, by applying heat using a microwave, conventional stove, or the like. Both the phase change from frozen to thawed and the rapid heating stress the emulsions. Freeze/thaw stability of sauces was evaluated as follows. Finished sauces were frozen and samples (about 40 g) of frozen sauce were microwaved in a 1250 W microwave oven on high for 1 minute. The sauces made using deamidated pea protein were stable over at least one freeze thaw cycle such that the emulsion remained intact after thawing with no pooling of oil on the surface of the sauce. In contrast, sauces made using pea protein isolates that were not deamidated, regardless of protein content, broke on thawing resulting in visible pooling of oil on the surface of the sauce when thawed after freezing.

### EXAMPLE 2: FROZEN DAIRY COMPOSITION MADE USING DEAMIDATED PROTEIN ISOLATE

Ability of deamidated pea protein to stabilize a 10% butterfat ice cream formulation was evaluated. Commonly, ice cream formulations use an emulsifier, like mono and diglycerides, to stabilize an emulsion of butter fat and aqueous component (whey) during homogenization. In the freezing process, these fat globules coalesce and surround air to form a network that stabilize air cells in the ice cream. This improves aeration and structures the ice cream, leading to a smoother and softer ice cream and slower melt. In this example, formulations were made using deamidated pea protein isolate (80% protein wt. %) as an emulsifier, pea protein isolate (non-deamidated) (80% protein wt/%) as an emulsifier, a mixture of mono and diglycerides as an emulsifier and negative control with no emulsifier. The formulations are reported in Table 2.

TABLE 2
Ice Cream Formulations

| | | | Pea | Deamidated |
|---|---|---|---|---|
| | Mono- & | No | Protein | Pea Protein |
| | Diglycerides | Emulsifier | Isolate | Isolate |
| Ingredient | % | % | % | % |
| Skim Milk | 50.1 | 49.8 | 48.3 | 48.3 |
| Heavy Cream | 24.3 | 25.0 | 25.0 | 25.0 |
| Corn syrup (28 | 4.0 | 4.0 | 4.0 | 4.0 |
| dextrose | | | | |
| equivalence) | | | | |
| Corn syrup (42 | 4.0 | 4.0 | 4.0 | 4.0 |
| dextrose | | | | |
| equivalence) | | | | |
| NFDM (low | 5.0 | 5.0 | 5.0 | 5.0 |
| heat)* | | | | |
| Sucrose | 12.0 | 12.0 | 12.0 | 12.0 |
| Mono-Diglyceride | 0.4 | 0.0 | 0.0 | 0.0 |
| Pea Protein Isolate | 0.0 | 0.0 | 1.5 | 0.0 |
| Deamidated Pea | 0.0 | 0.0 | 0.0 | 1.5 |
| Protein Isolate | | | | |
| Tara Gum | 0.2 | 0.2 | 0.2 | 0.2 |
| TOTAL | 100 | 100 | 100 | 100 |

NFDM low-heat refers to low-heat nonfat dry milk powder, which is a common commercial product that is used to fortify things like ice cream and other aqueous systems where solubility is important. Low-heat NFDM provides a more soluble dried milk powder than a high-heat NFDM powder. Low-heat NFDM powders are made by a drying process whereby water is removed from pasteurized skim milk in a process that heats the milk for no more than 160° F. (about 71° C.) for 2 minutes. In contrast, a high heat NFDM powder is heated for 190° F. (about 88° C.) for 30 minutes.

Ice creams were made over two days as follows. On day 1, corn syrups were melted into in skim milk on induction plate while stirring. Tara Gum was blended with a portion of the sucrose (25 g) and added to the milk. Mixture was whisked and added to Thermomix® mixer and then mixed for 5 minutes without heat at 2.0 speed. Remaining dry ingredients were mixed and hydrated at speed 2.0 for 15 minutes without heat. Mixture was then heated to heat to 75° C. while mixing for 30 minutes. Ice cream batter was mixed at speed for 2 until, the last 5 minutes of heating, when speed was lowered to 1.5 and heavy cream was added. Mixture was then homogenized in a two-stage homogenizer (e.g. from AVP) at 1500/500 psi (about 103/34 bar). Ice cream batter was then cooled over ice bath to 10° C. and then was stored at 4° C. for 24 hours.

On day 2, batter was churned using a benchtop freezer (Taylor) for 8 minutes to a temperature about −6° C. Ice cream was stored in freezer at −22° C.

Ice cream was analyzed for amount and size of air cells (measured by brightfield microscopy 200×), particle size of (fat globules and other solids), and stability during melt against separation of serum from ice cream.

It was observed that there were comparatively more air cells in the ice cream made using deamidated pea protein isolate than in ice cream made using no emulsifier or using pea protein isolate (non-deamidated). This indicates that ice cream using deamidated pea protein isolate was better aerated and had better comparative structure. Additionally, protein particles were visible in the ice cream using pea protein isolate (non-deamidated) but no pea protein was visible in ice cream using deamidated pea protein isolate indicating that the deamidated pea protein was substantially dissolved.

The size of particles in the ice creams was also measured using Beckman Coulter particle size analyzer and results are reported in Table 3. Sizes reported refer to the diameter of the particle in microns and the mean particle size is a volume weighted mean. D90 refers reports the diameter of a particles wherein 90% of the particles in the measured in the ice cream have diameter small than the D90 value. Particle size analysis was performed on the frozen ice cream.

TABLE 3
Particle size analysis ice cream

| | Mean Particle | d90 Particle |
|---|---|---|
| Sample | Size (microns) | Size (Microns) |
| No emulsifier | 2.565 | 4.871 |
| Mono/Diglyceride | 2.257 | 4.503 |
| Pea Protein Isolate | 7.623 | 26.83 |
| Deamidated Pea Protein | 2.664 | 5.457 |
| Isolate | | |

From Table 3, ice cream using deamidated pea protein had mean particle size and d (90) particle size (90% of particles smaller than) like ice creams made without emulsifier or with mono- and diglyceride. Also ice cream made using deamidated pea protein had mean particle size smaller than ice creams made with pea protein isolates (non-deamidated). This shows that the deamidated pea protein isolate dissolved in the ice cream batter better than non-deamidated pea protein isolate. It also shows that the deamidated pea protein isolate was substantially dissolved in the ice cream and was not separately identifiable from other non-protein particles in the ice cream. This shows that the deamidated pea protein isolate had solubility more like the ice creams using mono and diglyceride or no emulsifier and would be expected to provide better texture than ice creams using non-deamidated pea protein isolates, which contained visible protein particles.

Ice creams were also evaluated for serum separation during melting. The serum is an aqueous phase that does not have air bubbles inside it. The Melt-test/emulsion-separation-test was done as follows. One scoop of ice cream was plated and observed, with pictures taken every 10 minutes, starting at 0 minutes, through 60 minutes. The images were assessed for the serum separation meaning emergence of aqueous phase that that did not entrap air bubbles. Melted ice cream made without emulsifier and with pea protein isolate (non-deamidated) showed serum separation. In contrast, melted ice cream made with mono and diglyceride and deamidated pea protein isolate did not show serum separation and were stable meaning they the melted ice cream remained homogeneous with entrapped air bubbles after sitting for 60 minutes.

### EXAMPLE 3: COFFEE CREAMER COMPRISING DEAMIDATED PEA PROTEIN

Coffee creamer composition was made using deamidated pea protein using the formula reported in Table 4.

TABLE 4
Creamer Comprising Deamidated Pea Protein Isolate

| | Deamidated |
|---|---|
| Ingredients | Pea Protein |
| Water | 63.09 |
| Sucrose | 6 |
| Sodium Caseinate | 2.3 |
| Sodium Tripolyphosphate | 0.6 |
| (STPP) | |
| Disodium phosphate (DPP) | 0.5 |
| Mono- & diglyceride | 0 |
| High Oleic Soybean oil | 26 |
| Carrageenan | 0.01 |
| Deamidate Pea Protein Isolate | 1.5 |
| Pea Protein Isolate | |

Coffee creamers were made as follows. Oil phase was made by mixing the emulsifier (mono-& diglyceride, deamidated pea protein isolate, or pea protein isolate) to oil and the mixture and heating mixture to 65° C. Aqueous phase was prepared by first dissolving DPP/STPP in water at 60° C. and then adding sugar, sodium caseinate, starch and carrageenan. The aqueous phase was mixed until all solids were completely dissolved. The aqueous phase is then heated to 60° C. Aqueous phase and oil phase are mixed at 60° C. for 2 minutes in a Scott Turbon mixer using a rotational speed of the mixing paddle of 20 revolutions per minute. Coarse emulsion was homogenize at 60° C. the emulsion at in two passes first at 2500 psi (about 17.2 MPa) and then at 500 psi (about 3.4 MPa).

What is claimed:

1. An edible composition being a mixture comprising:
a. a fat component;
b. an aqueous component; and
c. a deamidated legume protein isolate in an amount from about 0.5 (wt. %), to about 3%, or about 2.5%, or about 2% or from about 1% (wt. %) to about 3%, or to about 2.5%, or to about 2% wherein the deamidated legume protein isolate has a degree of deamidation of between about 10% and about 25%, or about 10% to about 20%, or about 12% to about 20%, or about 15% to about 20%.

2. The composition of claim 1 wherein the deamidated legume protein isolate is a deamidated pea protein isolate.

3. The composition of claim 1 or 2 wherein the fat component is present in an amount from about 5% to about 50%, to about 40%, or to about 30%, or to about 20%, or to about 15%.

4. The composition of any one of claims 1 to 3 wherein the fat component is a plant derived oil.

5. The composition of any one of claims 1 to 4 wherein the fat component is a plant derived oil present in an amount of a greater than about 10%, or from about 11% to about 50%, or to about 40%, or to about 30%, or to about 20%, or to about 15%.

6. The composition of any one of claims 1 to 5 wherein the composition is an oil-in-water emulsion having a viscosity at least about 5,000 mPa·s or from about 5,000 or from to about 12,000 or to about 8,000 mPa·s at, or from about 6,000 to about 12,000 or to about 8,000 mPa·s at a temperature of about 20° to about 25° C.

7. The composition of any one of claims 1 to 6 wherein the composition is an oil-in-water emulsion and wherein after freezing and thawing the composition the composition has a viscosity at least about 5,000 mPa·s, or from about 5,000 to about 12,000 or to about 10,000, or to about 8,000 mPa·s or from about 6,000 to about 12,000 or to about 10,000 or to about 8,000 mPa·s at a temperature of about 20° to 25° C.

8. The composition of any one of claims 1 to 7 being an oil in water emulsions wherein after freezing and thawing the emulsion is not broken;
wherein, optionally, thawing is done by heating a 40 g sample of a frozen composition in a 1250 W microwave oven on high for one minute.

9. The composition of any one of claims 1 to 8 further comprising a starch, wherein the starch is selected from the group consisting of corn, potato, tapioca, rice, pea, waxy corn, waxy potato, way rice, waxy tapioca, and mixtures thereof, wherein, preferably, the starch is a thermally inhibited starch, and wherein, preferably, the starch is a waxy tapioca starch, wherein optionally the starch is present in an amount from about 1% to about 10%, or to about 5% (wt. %).

10. The composition of claims 1 to 9 being an oil-in-water emulsion having a pH from about 6 to about 8, or from about 6.5 to about 7.5.

11. The composition of any one of claims 1 to 10 being a vegan composition.

12. The composition of any one of claims 1 to 11 having a fat content in an amount from about 5% to about 30%, or to about 25%, or two about 20%, or to about 15% (wt. %), or from about 10% to about 30%, or to about 25%, or two about 20%, or to about 15% (wt. %);
wherein optionally the composition has a fat component present in an amount from about 5% to about 30%, or to about 25%, or two about 20%, or to about 15% (wt. %), or from about 10% to about 30%, or to about 25%, or two about 20%, or to about 15% (wt. %).

13. The composition of claim 12 wherein the fat is from an animal source, preferably from a dairy source.

14. The composition of claim 12 or 13 being a frozen dairy composition.

15. The composition of any one of claims 12 to 14 wherein the composition exhibits no serum separation during melting over a period of 60 minutes.

16. The composition as described in any foregoing claim wherein at least about 30% or at least about 35% of the deamidated legume protein isolated is dissolved in water.

17. The composition of any foregoing claim wherein the deamidated pea protein isolate is dissolved in an aqueous phase of the emulsion.

18. The composition of any foregoing claim having a particle size distributions having a mean particle size of less than about 5 microns or less than about 3 microns;
optionally wherein the composition is a frozen dairy composition.

19. The composition of any foregoing claim having a particle size distributions having a d (90) less than about 10 microns, or less than about 7 microns, or less than about 6 microns;
optionally wherein the composition is a frozen dairy composition.

20. The composition of any foregoing claim having a mean globule size less than about 20 microns, or less than about 15 microns, or about 10 microns or less.

21. The composition of any forgoing claim wherein the composition does not comprise a monoglyceride or a diglyceride.

22. A method of making a food composition comprising mixing a deamidated legume protein isolate as described in any foregoing claim with an aqueous component and a fat component to form a composition as described in any foregoing claim;
wherein optionally the mixing forms an emulsion,
wherein optionally after mixing the composition is frozen.

23. Use of a deamidated legume protein isolate as described in any foregoing claim as an emulsifier, wherein, optionally the deamidated legume protein isolate is a deamidated pea protein isolate.

24. Use of a deamidated legume protein isolate as described in claim 23 to replace monoglyceride and diglyceride, wherein optionally, the deamidated legume protein isolate is replacing monoglyceride and diglyceride in a frozen dairy composition.
